(19) United States
(12) Patent Application Publication
(10) Pub. No.: US 2015/0066966 A1
(43) Pub. Date: Mar. 5, 2015

(54) SYSTEMS AND METHODS FOR DERIVING, STORING, AND VISUALIZING A NUMERIC BASELINE FOR TIME-SERIES NUMERIC DATA WHICH CONSIDERS THE TIME, COINCIDENTAL EVENTS, AND RELEVANCE OF THE DATA POINTS AS PART OF THE DERIVATION AND VISUALIZATION

(71) Applicant: Know Normal, Inc., Raleigh, NC (US)

(72) Inventors: Shane Michael O'Donnell, Raleigh, NC (US); Maurice Bryant Cupitt, Durham, NC (US)

(21) Appl. No.: 14/477,763

(22) Filed: Sep. 4, 2014

Related U.S. Application Data
(60) Provisional application No. 61/873,805, filed on Sep. 4, 2013.

(51) Int. Cl. G06F 17/30; H04L 29/08

(52) U.S. Cl. CPC G06F 17/30569; H04L 67/10
USPC 707/756

(57) ABSTRACT

Disclosed herein are methods and systems for deriving, storing, querying, retrieving and visualizing one or more numeric baselines for time-series numeric data which considers the time, coincidental events and relevance of the time-series data points as part of the baseline derivation and visualization. According to an aspect, a method includes receiving one of time-series numeric data and event data in one or more formats from one or more other computing devices. The method also includes standardizing the one of time-series numeric data and event data to a common format. The method also includes analyzing the standardized data in the common format.

### CROSS REFERENCE TO RELATED APPLICATION

This application claims the benefit of and priority to U.S. Provisional Patent Application 61/873,805, filed Sep. 4, 2013, the entire content of which is incorporated herein in its entirety.

### TECHNICAL FIELD

The present disclosure relates to systems and methods for deriving, storing and visualizing a numeric baseline for time-series numeric data which considers the time, coincidental events and relevance of the data points as part of the derivation and visualization.

### BACKGROUND

The architecture and deployment of distributed software applications, including most web-based applications, has become ubiquitous in business application deployments where flexibility, performance, and scalability are critical. With distributed applications executing across multiple operating system instances on virtual and/or physical hardware, the information required to triage and troubleshoot problems, especially including performance-related problems, is significantly more complex and must be derived from multiple sources, each with its own limited perspective of the end-to-end system.

This shift toward complex, distributed applications has also created a new need for software tools that are focused on the specific transactions that happen between distributed systems. With this focus, the tools necessarily become much more specific to the transactions and technologies used in specific deployments. Ultimately, these tools can report significantly more data about smaller parts of the system which can be helpful, but often obscures the important system-level, end-to-end view of the application behind massive amounts of detail data about sub-components of the system.

Users responsible for the availability and performance of these distributed application systems often need a higher-level perspective of the data generated by these tools. Their view is benefited not only by having that higher-level perspective, but by having historical data (generated earlier by the same or related tools) that is relevant to the current application behavior. The historical data collected for comparison purposes should not be automatically qualified for use in comparison scenarios as other service-impacting incidents may have occurred during those time frames that could skew the reported information. Users would benefit from the ability to automatically (where possible) or manually (where necessary) identify those intervals which are atypical and should not be used as a basis for calculating a baseline for comparison purposes. Finally, users would benefit from a system where the data is finally scrutinized by its relevance for comparison purposes, especially where the distributed application may actually run in one of multiple configurations, each of which may add/remove processing power to/from the distributed application.

Once data is determined to be statistically-relevant for comparison purposes, that data must be appropriately normalized to standard formats for comparison within the same tool as well as across multiple different tools reporting similar data. This requires an understanding of the source and nature of the data and a mechanism not only to normalize the data, but to store it in concert with the additional descriptive information that allows it to be retrieved for appropriate comparison purposes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are the systems and methods for deriving, storing and visualizing a numeric baseline for time-series numeric data which considers the time, coincidental events and relevance of the data points as part of the derivation and visualization. According to an aspect, a method includes receiving one of time-series numeric data and event data in one or more formats from one or more other computing devices. The method also includes standardizing the one of time-series numeric data and event data to a common format. The method also includes analyzing the standardized data in the common format.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system in accordance with embodiments of the present disclosure;

FIG. 2 is a block diagram of an example scheme for scalable deployment of a system in accordance with embodiments of the present disclosure;

FIG. 3 shows an image of an example screen display from a web-based user interface in accordance with embodiments of the present disclosure;

FIG. 4 shows an image of an example screen display from a web-based user interface in accordance with embodiments of the present disclosure;

FIG. 5 is a flow chart of an example method for data acquisition in accordance with embodiments of the present disclosure;

FIG. 6 is a flow chart of an example method of user workflow for choosing data to analyze/visualize in accordance with embodiments of the present disclosure; and

FIG. 7 is a flow chart of an example method of user workflow for choosing data to analyze/visualize in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The various systems and methods described herein may be implemented with hardware, software, firmware, or combinations thereof. For example, the systems and methods described herein may be implemented by one or more processor and memory. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

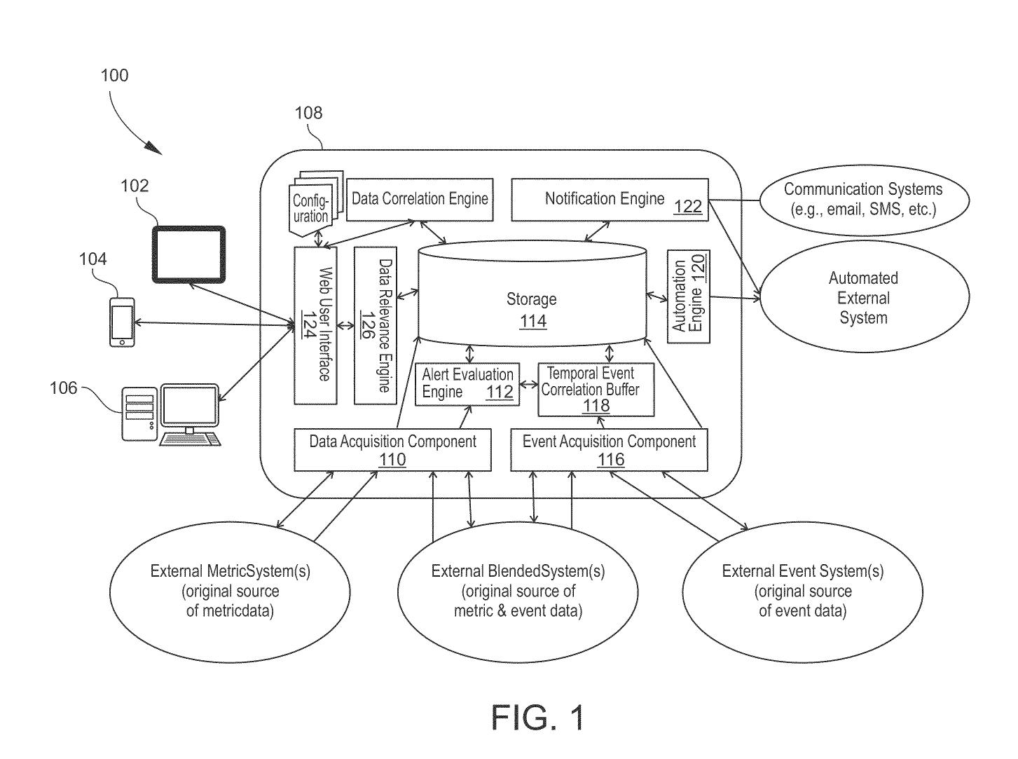

FIG. 1 illustrates a block diagram of an example system 100 in accordance with embodiments of the present disclosure. The diagram reflects the architectural decomposition of the system 100. Referring to FIG. 1, the system 100 may include various external sub-systems such as, but not limited to, a tablet computer 102, a smartphone 104, and a desktop computer 106. These external sub-systems are representative of user computing devices that can access the user interface of a computing device 108 in accordance with embodiments of the present disclosure. The computing device 108 may be a server or any other suitable computing device having hardware, software, firmware, or combinations thereof for implementing the functionality described herein. Also, it is noted that although the computing device 108 is depicted as being a single computing device, it should be appreciated that the computing device 108 may be implemented by one or more computing devices such as a collection of servers or other computers that are configured to implement the functionality of the computing device 108.

The computing device 108 and the tablet computer 102, the smartphone 104, and the desktop computer 106 may be configured to suitably communicate via any suitable technique. For example, the components may be communicatively connected via a suitable network. In this example, the components are communicatively connected via the Internet.

The computing device 108 may include a data acquisition component 110 having one or more mechanisms or interfaces configured to interact with external sub-systems. The data acquisition component 110 may also actively retrieve data from the external sub-systems via a programming call to an Application Programmatic Interface (API) or other suitable mechanism which can facilitate the access of data by an external sub-system. The data acquisition component 110 may also be configured for the passive receipt of electronic data from an external source. This may be facilitated by the ad hoc transfer of numeric data from an uncontrolled external system associated with one or more entities/devices/systems known by the system 108, the scheduled transfer of numeric data from an uncontrolled external system associated with one or more entities/devices/systems known by the system 108, the user-initiated. upload of numeric data associated with one or more entities/devices/systems known by the system 108, a process-initiated or otherwise automated upload of numeric data associated with one or more entities/devices/systems known by the system 108, or any other suitable mechanism which allows an external system or user to electronically transfer data that is recognizable by the component or the transfer of unrecognized data that is also described by a manifest accompanying the upload, coincidentally with the upload or at some time before or after the upload of the data itself.

The data acquisition component 110 may be configured to access controls and functionality put into place by the external sub-system, including but not limited to, user credentials (i.e., user names or IDs, passwords, and the like), encryption/decryption, key-based access systems (e.g., API keys, data access keys, and the like), or any other forms of electronic controls designed to prevent, control, or otherwise limit access to data. In addition, the data acquisition component 110 may be configured to implement and enforce data access controls which restrict or limit the transmission or uploads of data to or through the component itself.

Upon receiving data through active or passive means, the data acquisition component 110 can reformat the data received into a common format that, where possible, strips the data down to its simplest form, removing anything that is source-specific and distilling it down to its data source, the device/system/entity that is being monitored, the specific aspect of the device/system/entity that is being measured, the nature of that measurement and any relationship it may have to previous or fixture values collected for the same measurement, the value of the current measurement, the timeframe at which the measurement was taken, and the units in which the value is reported. This simplistic common data format the data can be processed by an alert evaluation engine 112 with no modification based on the source, type, etc. of the original measurement and stored in any one or more of the discrete systems within the storage component 114 (e.g., memory, hard disk, etc.). The data acquisition component 110 may also be equipped with the ability to write the data directly to the storage component 114 where it is effectively cached, allowing the data acquisition component 110 and/or the alert evaluation engine 112 to access the raw data for processing and aggregation at a later time. This can facilitate the alert evaluation engine's 112 ability to complete current and/or queued work before needing to address the immediate workload demands of newly received data.

An event acquisition component 116 may be considered a counterpart to the data acquisition component 110, in that it has similar responsibilities as related to event-oriented data versus the numeric data for which the data acquisition component 110 is responsible. The event acquisition component 116 is responsible for the active retrieval of event-oriented data from external sub-systems and/or the passive receipt of event-oriented data of any nature from external sub-systems. Once it has data from any source, the data acquisition component 110 will translate the data included in the original event into a common event format and present it to a temporal event correlation buffer 118, storing the data directly, or some combination thereof. The common event format distills the original event down into its source, the devise/system/entity that's reporting the event, the timestamp of when the event was reported (subject to system time/time zone of the originating device), the severity of the event, and the text message associated with the event itself. This common event format facilitates the processing, comparison, and display of diverse event types/formats from a multitude of different sources.

Once data has been collected by either of the acquisition components 110 and 116, the data may subsequently be eligible for processing by the alert evaluation engine 112 (for numeric data) or the temporal event correlation buffer 118 (for event-oriented data), if appropriate. Otherwise, the data can be written directly to the storage component 114.

Once the alert evaluation engine 112 has received a new data point associated with a specific metric, it may evaluate the new data point in the context of previously received data points. The alert evaluation engine 112 may compare the metric set to thresholds determined by calculating practical limits from previously received data specific and relevant to the time of day and day of week at which the current data point was received and evaluated rules specified in configuration and identified in the alert evaluation engine's 112 configuration. If the alert evaluation engine 112 has determined that a threshold has been violated and that further action is specified via configuration, it can generate a message to an automation engine 120 and/or a notification engine 122 for further action.

It should be noted that the alert evaluation engine 112 can maintain information on previous thresholds that have been violated on a per-metric basis. This information is intended to facilitate the alert evaluation engine's 112 ability to track which alert messages have been generated and to be able to send a subsequent message when the condition that caused the initial message to be created has been cleared.

Once the temporal event correlation buffer 118 has been populated with newly received events, it can identify related events using any of multiple fields of the original events including for example, but not limited to, time of the event, source of the event, nature of the event, severity of the event, deltas in time between event generation at the source and receipt by the system, and/or other aspects of the event. This information is intended to facilitate the alert evaluation engine's 112 ability to track which alerts have been generated and to be able to update those previously generated alerts when the condition that caused the initial alert to be created has cleared or has otherwise changed. It may also determine that certain events are related due to a topological relationship, wherein one data source is specifically “upstream” or “downstream” of another. If related events are identified, they may be modified, used as a criteria for a new event, deleted, and/or otherwise manipulated. Processed events can be stored in the “Storage” component for future access/processing/correlation.

With the storage component 114 populated with some amount of data, the user interface can be presented to the user, allowing the user multiple mechanisms to interact with the data, including but not limited to the following: browsing the relevant data set for exploratory, learning, and familiarization with the data; selecting an item from the data set to see relevant, related data associated with the selected item (included correlated numeric and/or event data), querying the data set seeking any related data or events associated with a given external starting data point, viewing reports or user interfaces which leverage the data in such a way to show a single scalar number that represents the data, and/or a visualized pattern of data reflecting a changing-over-time baseline.

In order to present the data to a user device via a web user interface 124, the system may utilize a data relevance engine 126. The data relevance engine 126 may be configured to function as a semantically-aware query engine, accessing data—including derived baselines and correlated events—based on the criteria specified by the user. The user may specify this criteria explicitly by communicating the criteria to the data relevance engine 126 via the user interface 124 or implicitly through selecting options in the user interface 124 that define or build a query for relevant data points.

With continuing reference to FIG. 1, the automation engine 120 may be a configurable component that is responsible for leveraging the system's derived baseline information and stored metrics to advise, inform, control, or otherwise interact with external sub-systems. As an example, an external sub-system may be configured to invoke a script on another computer system if a certain performance condition is met. The automation engine 120 may be called upon in that scenario to determine if the performance condition has been met, to validate that the performance condition has been met, to validate secondary requirements based on other metrics or comparison to baselines prior to sending the text, or to create an entirely new criteria where the performance condition is a comparison between a raw or derived metric and a calculated baseline for the period in which the metric participates. The automation engine 120 can be driven largely by configuration and can take action based on many different controls, including but not limited to the receipt of data, the collection of data, a configured schedule, receipt of an event, notification from an external system, notification from an internal component or engine within the system, or other drivers.

The notification engine 122 can function as a translator, taking commands and/or data feeds that match corresponding actions in the notification engine's 122 configuration, and translating them to invoke notifications to end users or other external sub-systems. Those notifications destined for users are typically carrying information about a specific event or performance condition that may merit user intervention, and those destined for external systems are typically formatted in a predetermined format that is specified and consumable by the remote system or an API presented by a remote system.

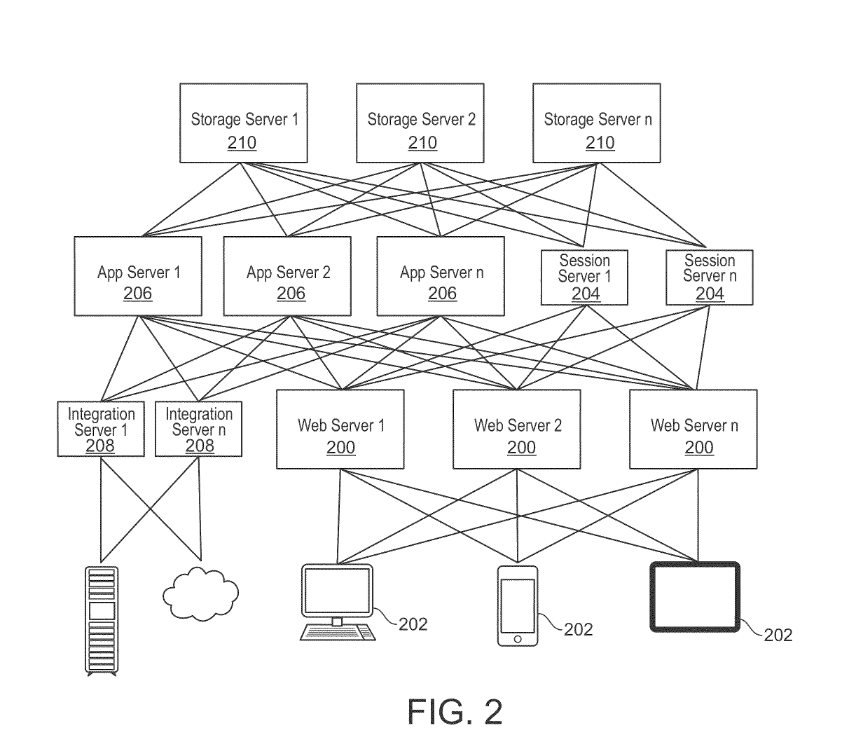

FIG. 2 illustrates a block diagram of an example scheme for scalable deployment of a system in accordance with embodiments of the present disclosure. Referring to FIG. 2, the model includes boxes denoted as “Function Server x,” where Function describes the role of the server and ‘x’ is a number, or n, representing an arbitrary integer larger than the highest number displayed, indicating scalability to an arbitrary number of servers. The boxes identified as web servers 200 are configured to provide service to web browsers hosted on user computing devices 202 (e.g., desktop computers, laptops, smartphones, tablets, and the like). The web servers 200 are primarily responsible for hosting static and dynamic content required to render the visualizations to end users at computing devices 202.

With continuing reference to FIG. 2, session servers 204 are each configured to provide stateful information about the current session between the web browser of a computing device 202 and the associated web server 200. That state information can be maintained away from the web servers 200 themselves so that any request from any web browser can be fulfilled by any web server 200. There is no requirement for subsequent requests from one web browser to be directed to the same server that answered any previous requests. This affords the ability to scale to n web servers 200 without having to worry about the request load imposed on any one server. The load can be distributed across the servers with rough parity through the use of any load-balancing technologies, including but not limited to hardware-based load balancers, software-based load balancers, round-robin DNS-based load balancers, or other similar technologies. The diagram of FIG. 2 reflects the use of a DNS-based load balancer, which is not pictured in FIG. 2 for convenience of illustration.

App servers 206 are each configured to provide the core functionality of the application, including all of the data engines or components (i.e., the data acquisition component 110, the event correlation component 116, and the data relevance engine 126 shown in FIG. 1). The app servers 206 can move inbound data through the application logic to store it in appropriate formats in the storage servers, as well as providing outbound data to appropriately fulfill user requests. With this division of responsibility, the web servers 200 are allowed to focus on the mechanics of browser communication and serving content to the browser, while any application-specific and/or data-specific processing is offloaded to the app servers 206.

An integration server 208 reflects systems that are responsible for providing the architectural external integration functions, including data acquisition, event acquisition, and automation for external systems. Effectively, these servers 208 can provide a platform to manage authentication/authorization for connections to external sub-systems as well as execution environments for logic that receives data from external systems and prepares it for processing and/or storage. These servers also keep the less predictable load of data acquisition from being intermingled with web server loads. This allows web server traffic, which is optimized for user experience, to be protected from unexpected demands of large data uploads or bursts of events from uncontrolled sources, as well as providing typical security functions including, but not limited to, authentication, authorization, session auditing, and session management.

Storage Servers 210 reflect systems dedicated to storing and fulfilling queries for data from other servers in the system. These devices may use one or more storage technologies, including but not limited to relational databases, non-relational “NoSQL” databases, file system-based storage, distributed and/or networked file system storage, or other suitable technologies.

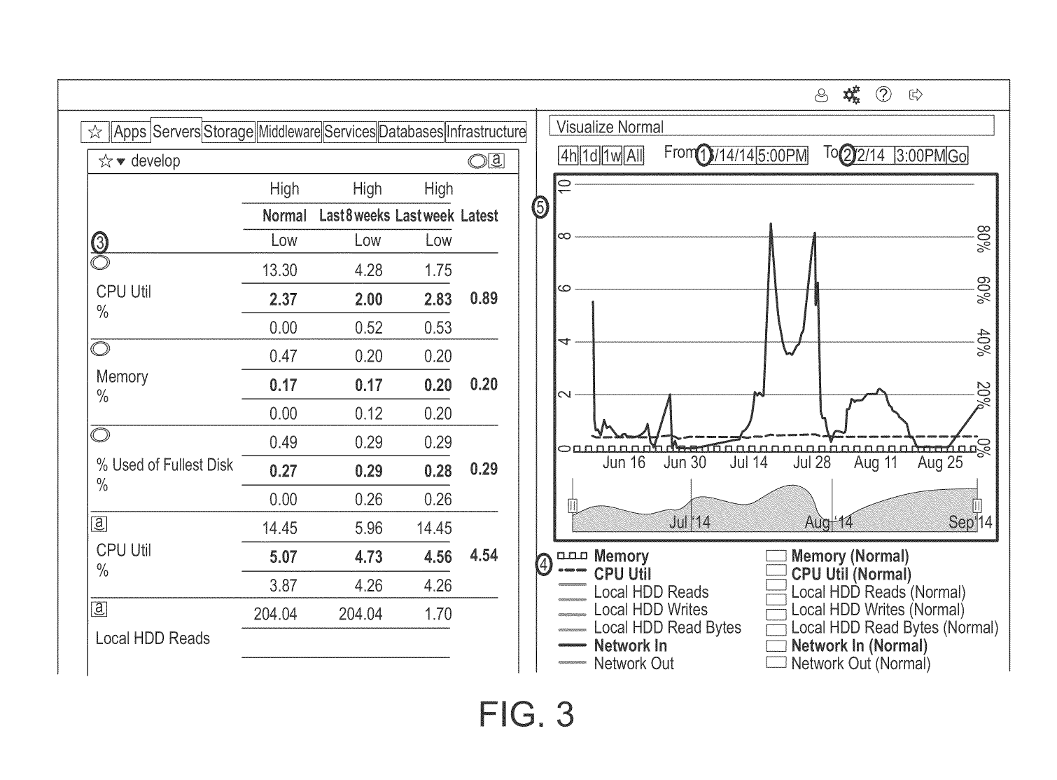

FIG. 3 shows an image of an example screen display from a web-based user interface in accordance with embodiments of the present disclosure. Referring to FIG. 3, the figure includes reference numerals 1-5 encircled, with numeral 5 associated with a large square to the right of the numeral 5.

Reference numeral 1 indicates a “starting time” text area. This text area allows the end user to select the starting time of the interval of data he or she wishes to view. Based on the data set selected, the text area is automatically pre-populated by the system with the earliest date represented in the data set.

Reference numeral 2 indicates an “ending time” text area. This text area allows the end user to select the ending time of the interval of data he or she wishes to view. Based on the data set selected, the text area is automatically pre-populated by the system with the latest date represented in the data set.

Reference numeral 3 indicates the “dashboard” area. The “dashboard” is a collection of numeric metrics (i.e., things that are being measured) and values (i.e., the measurements taken of specific metrics), raw, and/or derived, that are dynamically chosen by the system as the most typically important numeric metrics to consider in atypical performance situations. For example, reference numeral 3 reflects a dashboard populated with the numeric values for troubleshooting a server with multiple metric data sources.

For each of the metrics, the dashboard includes several performance baseline measurements for the current hour, each derived from different periods prior to the current hour. In the case of this dashboard, the user is shown the “high” and “low” extremes of the “normal” performance range based on all data that the system has for the current day of week/hour of day combination, “high” and “low” extremes of the “normal” performance range based on the available data for the trailing 8 weeks, “high” and “low” extremes of the “normal” performance range based on the available data for the trailing 4 weeks, and the most recently received value, as measured by the tool or API providing the data.

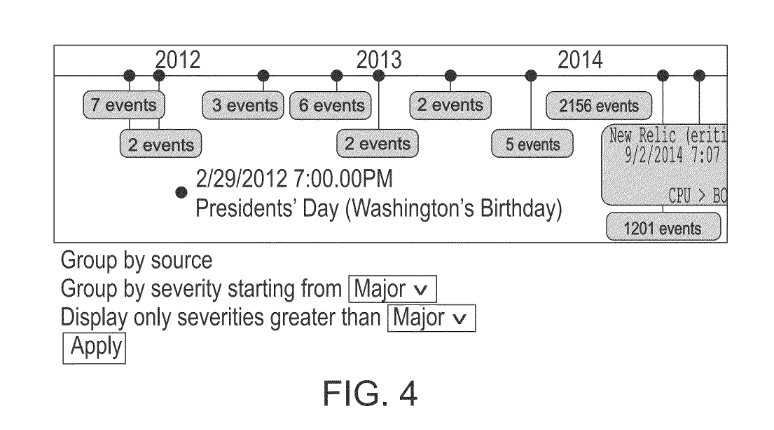

Reference numeral 4 indicates a graphical legend indicating what metrics are available for contextual analysis, with each metric individually selectable for inclusion (or removal) from the chart. If the metric in the graphical legend is selected, a colored block appears in the legend entry that reflects the color of the plotted line or area on the larger plotted chart. Reference numeral 5 indicates a combined line and area chart. In this portion of the user interface, the line chart contains a time value x-axis which also serves as a time value axis for the event area below the x-axis (e.g., see FIG. 4). If a selected metric is selected again, the legend acts as a toggle to turn off the display of that metric's values on the chart, and a shaded or colored area to the left of the metric name as well as the metric's name itself can be rendered in grey.

FIG. 4 shows an image of an example screen display from a web-based user interface in accordance with embodiments of the present disclosure. Referring to FIG. 4, the screen display shows an event timeline, where “events” corresponding to occurrences of atypical behavior in the environment can be rendered as a block of time (stretching in a colored block from one time value to another) or as an instantaneous instance of an event, occurring at a specific point in time. In the instantaneous instance case, the event is rendered as a small icon whose horizontal alignment indicates the time of the occurrence of the event (referencing the x-axis above), followed by a brief textual description. Additionally, the event timeline is depicted in context with the timeframe selected on the chart (which appears immediately above the timeline in the web user interface). Events displayed in the event timeline can be grouped by the “source” of the event, the “severity” of the event, or filtered to display only more important events, with the option to display only events of a specific severity or higher. This is to facilitate the display of the maximum amount of information important to the user at the time of use.

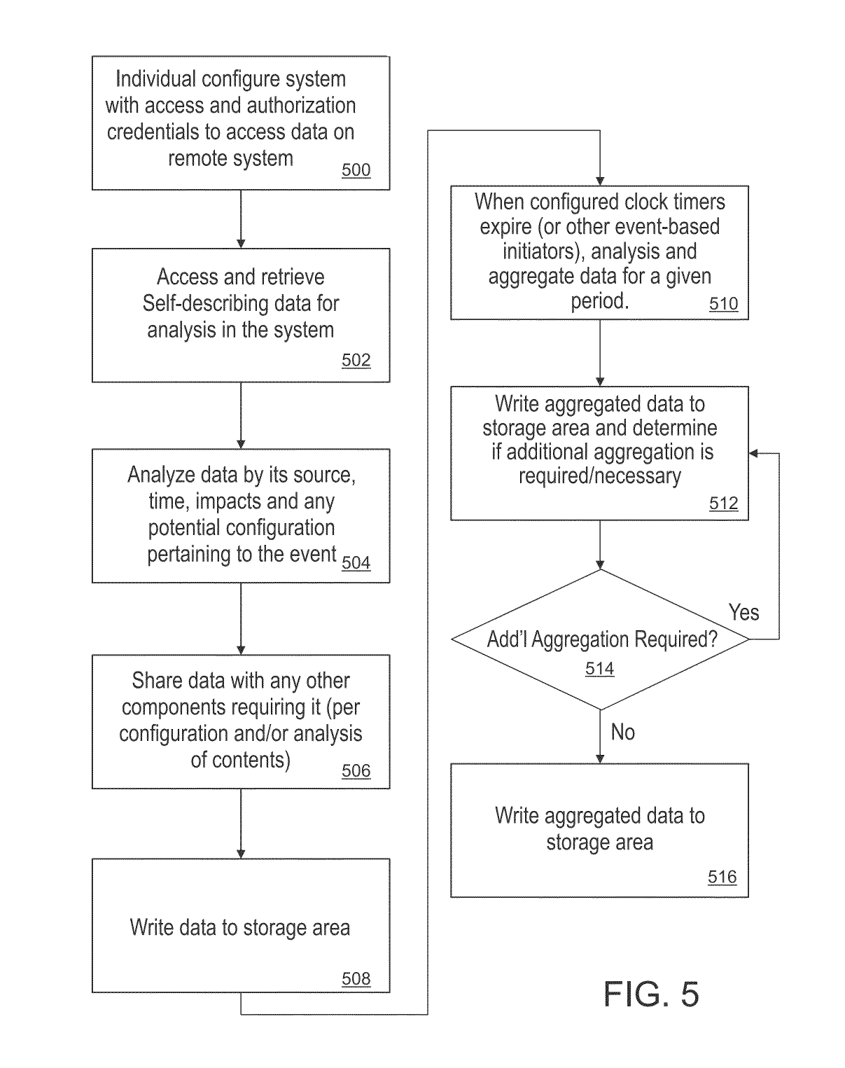

FIG. 5 illustrates a flow chart of an example method for data acquisition in accordance with embodiments of the present disclosure. The method is described in this example as being implemented by the system shown in FIG. 1, although it should be understood that the method can be implemented by any other suitable system. Referring to FIG. 5, the method includes configuring 500 the system with access and authorization credentials to access data on a remote system. For example, an individual operating a computing device, such as the tablet computer 102 shown in FIG. 1 may access be used to configured the system with access and authorization credentials to access data. The method of FIG. 5 also includes accessing and retrieving 502 self-describing data for analysis in the system. For example, in FIG. 1, the computing device 108 may access and retrieve data from the tablet computer 102.

The method of FIG. 5 includes analyzing 504 data by its source, time, impacts, and any potential configuration pertaining to the event. Continuing the aforementioned example, the computing device 108 may receive multiple events from an external system via the event acquisition component 116 and hand those events off to the temporal event correlation buffer 118, where they may be analyzed by their source, the time that they were generated, and identifying characteristics of the events themselves to identify one or more of the events as a duplicate of an earlier event.

The method of FIG. 5 includes sharing 506 data with any other components requiring it (per configuration and/or analysis of contents). Continuing the aforementioned example, the computing device 108 may be configured such that when duplicate events are received and identified by the temporal event correlation buffer 118, the temporal event correlation buffer 118 then places a message on a queue in the storage component 114 to be read by the notification engine 122 causing it to notify all recipients of a notification associated with the original event that some number of duplicate events have been received.

The method of FIG. 5 includes writing 508 data to a storage area. Continuing the aforementioned example, the computing device 108 may be configured such that the temporal event correlation buffer 118 then opts to update the contents of the original event (previously received and stored in storage component 114) with a count of the number of duplicate messages received and a list of the timestamps at which they were received.

The method of FIG. 5 includes analyzing and aggregating 510 data for a predetermined period when configured clock timers expire (or other event-based initiators). Continuing the aforementioned example, the computing device 108 may be configured such that after some configurable period (e.g., 75 minutes) have elapsed following the receipt of the last duplicate event as identified by the temporal event correlation buffer 118, the complete list of events received—including counts and timestamps of duplicates—is tallied for the preceding hour.

The method of FIG. 5 includes writing 512 aggregated data to storage area and if additional aggregation is required/necessary. Continuing the aforementioned example, the computing device 108 may be configured such that the temporal event correlation buffer 118 then writes the aggregate tallies of events and duplicate events for the preceding hour to storage component 114.

The method of FIG. 5 includes determining 514 whether additional aggregation is required. If it is determined that additional aggregation is required, the method may return to block 512. Continuing the aforementioned example, the computing device 108 may be configured such that the data correlation engine may be prompted by the temporal event correlation buffer 118 after it writes the final duplicate event update to storage 114 for a given hour, to read all event aggregate and event duplicate aggregate tallies from storage 118 and to calculate a system-wide baseline for that “hour of week” to create an “hour of week” baseline expectation of the number of events and duplicate events normally received during that period.

If it is determined at block 514 that additional aggregation is not required, the method of FIG. 5 includes writing aggregation data to the storage area. Continuing the aforementioned example, the computing device 108 may be configured such that, as a failsafe mechanism, that once no more data is required to be aggregated for a given period that all components capable of writing aggregated data to storage 114 are prompted to write any additional aggregate data they may hold to storage 114.

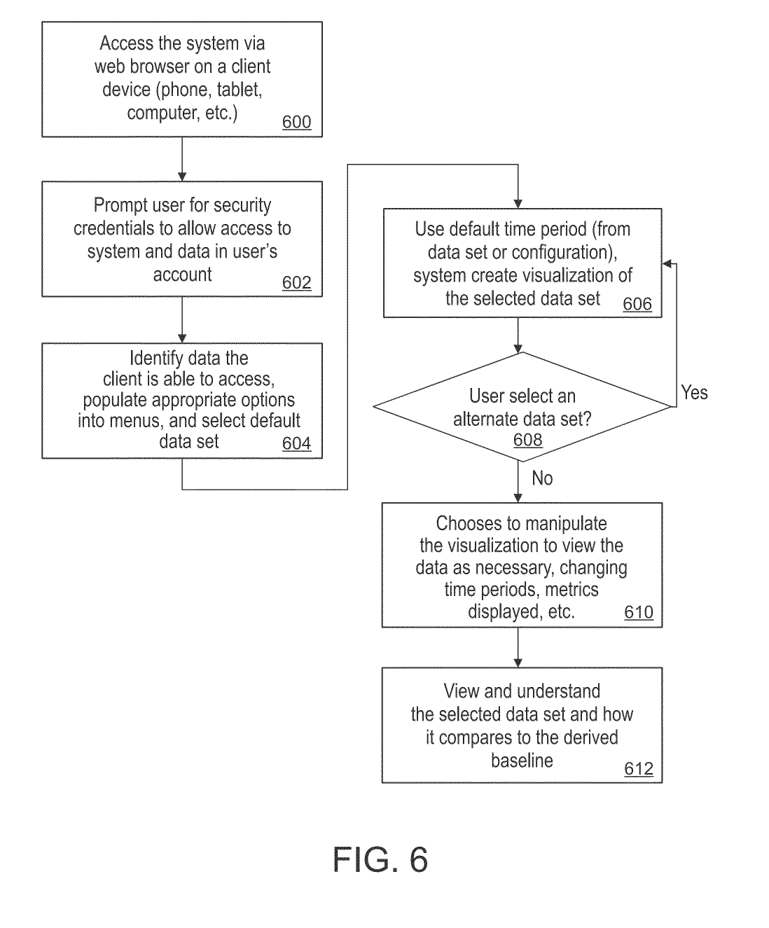

FIG. 6 illustrates a flow chart of an example method of user workflow for choosing data to analyze/visualize in accordance with embodiments of the present disclosure. The method is described in this example as being implemented by the system shown in FIG. 1, although it should be understood that the method can be implemented by any other suitable system. Referring to FIG. 6, the method includes a user accessing 600 the system via a web browser on a client device (e.g., phone, tablet computer, desktop computer, and the like). For example, the computing device 108 may have a user open a web browser on their desktop computer 106 and instruct the browser to access a web server.

The method of FIG. 6 includes prompting 602 a user for security credentials to allow access to system and data in a user's account. Continuing the aforementioned example, the computing device 108 may respond to the user's web browser request by establishing a secure HTTP session and requesting that the user enter their user ID and password.

The method of FIG. 6 includes identifying data the client is able to access, populate appropriate options into menus, and select default data set (block 604). Continuing the aforementioned example, the computing device 108 may receive the user's ID and password, at which time the web user interface 124 can validate that the password, is valid for that user account and if so, will ask the data relevance engine 126 to determine the scope of data the user is authorized to view and will assemble links to pages describing that data into HTML to be returned to the user's web browser via the web user interface 124.

The method of FIG. 6 includes using default time period (from data set or configuration), and create visualization of the selected data set (block 606). Continuing the aforementioned example, the computing device 108 may, after sending the descriptive HTML pages to the web browser (604), the web user interface 124 can ask the data relevance engine 126 to determine if a “preferred” data set has been selected by the user, and if so, send that to the user's web browser. If no default data set is identified, the data relevance engine 126 can further analyze the data to not only understand what data is available, but also to understand which metrics have values associated with them and the timeframes of those values. Depending on what metric values are available, a default data set can be selected by the data relevance engine 126, pushed to the client via the web user interface 124, and default views populated with that metric value.

The method of FIG. 6 includes determining 608 whether the user selected an alternate data set. In response to determining that the user selected an alternate data set, the method may return to block 606. Continuing the aforementioned example, the computing device 108 may receive a request from the uses browser to access an alternate data set. If that request is received by the web user interface 124, the data relevance engine 126 is asked if the user has the appropriate authorizations to view the alternate data set and if so, the steps in 606 are repeated.

The method of FIG. 6 includes a user choosing 610 to manipulate the visualization to view the data as necessary, changing time periods, metrics displayed, etc. Continuing the aforementioned example, the computing device 108 may request via the web user interface 124 that additional data points or different granularities of performance metrics are required to create a new chart view or a new timeframe for the chart. When this request is received, the web user interface 124 can ask the data relevance engine 126 to validate the request and if valid, provide the requested data from storage 114.

The method of FIG. 6 includes viewing and understanding the selected data set and how it compares to the derived baseline (block 612). Continuing the aforementioned example, the computing device 108 may respond to any requests for metric values that are returned to the user's web browser via the web user interface 124 with the requested data as well as the aggregated metric baseline data values associated with any requested time periods, and the web user interface 124 returns the requested values and corresponding baseline values to the user's web browser, which they can then use to do an analysis of the performance during the requested timeframe.

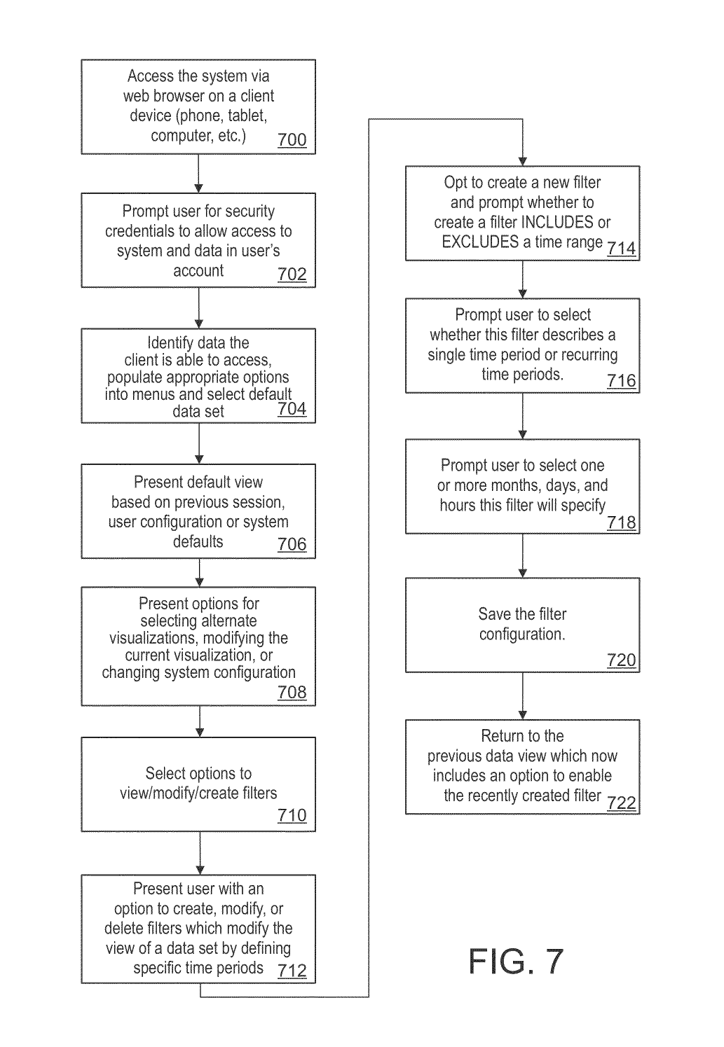

FIG. 7 illustrates a flow chart of an example method of user workflow for choosing data to analyze/visualize in accordance with embodiments of the present disclosure. The method is described in this example as being implemented by the system shown in FIG. 1, although it should be understood that the method can be implemented by any other suitable system. Referring to FIG. 6, the method includes a user accessing 700 the system via a web browser on a client device (e.g., smartphone, tablet computer, desktop computer, and the like). For example, the computing device 108 may have a user open a web browser on their desktop computer 106 and instruct the browser to access the web server located at a web server.

The method of FIG. 7 includes a user being prompted 702 for security credentials to allow access to system and data in the user's account. Continuing the aforementioned example, the computing device 108 may respond to the user's web browser request (600) by establishing a secure HTTP session and requesting that the user enter their user ID and password.

The method of FIG. 7 includes identifying 704 data the client is able to access, populating appropriate options into menus and default data set. Continuing the aforementioned example, the computing device 108 may receive the user's ID and password, at which time the web user interface 124 can validate that the password is valid for that user account and if so, can ask the data relevance engine 126 to determine the scope of data the user is authorized to view and will assemble links to pages describing that data into HTML to be returned to the user's web browser via the web user interface 124.

The method of FIG. 7 includes presenting 706 a default view based on a previous session, user configuration, or system defaults. Continuing the aforementioned example, the computing device 108 may, after sending the descriptive HTML pages to the web browser (604), the web user interface 124 can ask the data relevance engine 126 to determine if a “preferred” data set has been selected by the user and if so, send that to the user's web browser. If no default data set is identified, the data relevance engine 126 can further analyze the data to not only understand what data is available, but also to understand which metrics have values associated with them and the timeframes of those values. Depending on what metric values are available, a default data set can be selected by the data relevance engine 126, pushed to the client via the web user interface 124, and default views populated with that metric values.

The method of FIG. 7 includes presenting 708 options for selecting alternate visualizations, modifying the current visualization, or changing system configuration. Continuing the aforementioned example, the computing device 108 may present options in the user's web browser that allow the user to control, shape, and manipulate their view of the data, select alternate data, or modify the configuration of the computing device 108.

The method of FIG. 7 includes selecting 710 options to view/modify/create filters. Continuing the aforementioned example, the computing device 108 may receive a request from the user's web browser at the web user interface 124 to view, modify, or create filters to eliminate some portion of the data from their current view or the calculation of their baselines.

The method of FIG. 7 includes presenting 712 a user with an option to create, modify, or delete filters which modify the view of a data set by defining specific time periods. Continuing the aforementioned example, the computing device 108 may, upon receipt of a request to manipulate filters, the web user interface 124 asks the data relevance engine 126 to validate that the user ID associated with this session has permissions to modify filter settings and upon confirmation, the web user interface 124 delivers HTML to the user's web browser which facilitates the manipulation of filters.

The method of FIG. 7 includes opting 714 to create a new filter and prompt whether to create a filter includes or excludes a time range. Continuing the aforementioned example, the computing device 108 may present HTML and browser-executable scripts that constitute a “filter manipulation wizard,” which allows the user to, locally in their web browser, create a complex request to create a new filter, which is followed by a local web browser prompt to identify the filter for inclusion of data or exclusion of data.

The method of FIG. 7 includes prompting 716 the user to select whether this filter describes a single time period or recurring time periods. Continuing the aforementioned example, the computing device 108 may present HTML and browser-executable scripts that continue the “wizard” 714 to request the inclusion of information about whether the filter should be evaluated one time or on a recurring basis.

The method of FIG. 7 includes prompting 718 to select one or more months, days, and hours this filter will specify. Continuing the aforementioned example, the computing device 108 may present HTML and browser-executable scripts that continue the “wizard” 714 to prompt for the specific time period(s) that the filter can address,

The method of FIG. 7 includes saving 720 the filter configuration. Continuing the aforementioned example, the computing device 108 may receive a request from the user to create a new filter with all of the specifications collected by the “wizard” 714 following the user's selection of “OK” at the completion of the “wizard” 714, When this request is received by the web user interface 124, it stores the filter information in storage 114. Once the filter data is safely stored, the web user interface 124 informs the user via the web browser that the “Save” action was successfully completed.

The method of FIG. 7 includes returning 722 the user to the previous data view which now includes an option to enable the recently created filter. Continuing the aforementioned example, the computing device 108 may present HTML and browser-executable scripts that allow the user to return to the data view they had been viewing prior to creating the new filter, which can now be updated by the web user interface 124 to include the new filter as an option that the user can choose to enable.

In accordance with embodiments, correlation of data may be implemented by any suitable technique. For example, data correlation may use one or more of a Pearson product-moment correlation coefficient (PPMCC), Spearman's rank correlation coefficient, and Kendall's rank correlation coefficient. Correlation of data may include: analyzing the most significantly correlated and anti-correlated data making up a dynamically ascertained or manually-configured confidence interval for known-causal values; and removing the known-causal values into a primary set, wherein the remaining members of the confidence interval are most closely correlated as members of a secondary set reflecting pure correlation and non-causal relationships.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
using a computing device comprising at least one processor and memory for:
receiving one of time-series numeric data and event data in one or more formats from one or more other computing devices;
standardizing the one of time-series numeric data and event data to a common format; and
analyzing the standardized data in the common format.

2. The method of claim 1, further comprising correlating the one of the time-series numeric data and event data to one of other time-series numeric data and other event data.

3. The method of claim 2, wherein correlating comprises correlating the one of the time-series numeric data and event data to the one of other time-series numeric data and other event data using any of a plurality of fields displayed in a common format.

4. The method of claim 1, wherein the computing devices are communicatively connected via the Internet.

5. The method of claim 1, further comprising presenting the analyzed data in the common format.

6. The method of claim 5, wherein presenting the analyzed data comprises presenting the analyzed data via a user interface.

7. The method of claim 5, wherein presenting the analyzed data comprises displaying the analyzed data via a display.

8. The method of claim 1, further comprising correlating the data using one of a Pearson product-moment correlation coefficient (PPMCC), Spearman's rank correlation coefficient, and Kendall's rank correlation coefficient.

9. The method of claim 1, further comprising correlating the data by:
analyzing the most significantly correlated and anti-correlated data making up a dynamically ascertained or manually-configured confidence interval for known-causal values; and
removing the known-causal values into a primary set, wherein the remaining members of the confidence interval are most closely correlated as members of a secondary set reflecting pure correlation and non-causal relationships.

10. The method of claim 1, further comprising determining the one of the time-series and event data within a predetermined time period, and
wherein standardizing and analyzing comprises standardizing and analyzing the data within the predetermined time period.

11. A system comprising:
a computing device comprising at least one processor and memory configured to:
receive one of time-series numeric data and event data in one or more formats from one or more other computing devices;
standardize the one of time-series numeric data and event data to a common format; and
analyze the standardized data in the common format.

12. The system of claim 11, wherein the computing device is configured to correlate the one of the time-series numeric data and event data to one of other time-series numeric data and other event data.

13. The system of claim 12, wherein the computing device is configured to correlate the one of the time-series numeric data and event data to the one of other time-series numeric data and other event data using any of a plurality of fields displayed in a common format.

14. The system of claim 11, wherein the computing devices are communicatively connected via the Internet.

15. The system of claim 11, wherein the computing device is configured to present the analyzed data in the common format.

16. The system of claim 11, further comprising a user interface configured to present the analyzed data.

17. The system of claim 15, further comprising a display configured to display the analyzed data.

18. The system of claim 11, wherein the computing device is configured to correlate the data using one of a Pearson product-moment correlation coefficient (PPMCC), Spearman's rank correlation coefficient, and Kendall's rank correlation coefficient.

19. The system of claim 11, wherein the computing device is configured to:
analyze the most significantly correlated and anti-correlated data making up a dynamically ascertained or manually-configured confidence interval for known-causal values; and
remove the known-causal values into a primary set, wherein the remaining members of the confidence interval are most closely correlated as members of a secondary set reflecting pure correlation and non-causal relationships.

20. The system of claim 21, wherein the computing device is configured to:
determine the one of the time-series and event data within a predetermined time period; and
standardize and analyze the data within the predetermined time period.
